(19) United States
(12) Patent Application Publication
(10) Pub. No.: US 2009/0217944 A1
(43) Pub. Date: Sep. 3, 2009

(54) Mobile Vehicle Washing Apparatus

(76) Inventors: Javier Munera, Revere, MA (US); Yesid Acosta, Malden, MA (US)

Correspondence Address: LAMBERT & ASSOCIATES, P.L.L.C., 92 STATE STREET, BOSTON, MA, 02109-2004, US

(21) Appl. No.: 12/039,815

(22) Filed: Feb. 29, 2008

(51) Int. Cl. B60S 3/06; B08B 3/02

(52) U.S. Cl. 134/6; 134/32; 134/34; 134/123

(57) ABSTRACT

A mobile vehicle washing apparatus in which the length, width and height of the apparatus may each be adjusted to the size of the vehicle to be washed and for easier transport. The frame dimensions may be adjusted by a system of cranks found on each frame member that may need to be adjusted. Also, attached to the frame are swinging arm members that may clean the bottom side of a vehicle passing through them. Powered brush members are used in the apparatus as a means to scrub vehicle surfaces. The cleaning and rinsing fluids pass through a series of hoses and nozzles mounted about the frame so that the tops and left and right sides of the vehicles being cleaned may be covered by said fluids.

### FIELD OF THE INVENTION

The present invention relates generally to a mobile automobile washing apparatuses that can easily be moved from one place to another, wherein automobiles may move through the apparatus itself, or the apparatus itself may move across the length of any given automobile.

### REFERENCES

In general within the art, descriptions of automobile washes and mobile automobile washes are found in U.S. Pat. No. 4,453,284 set forth by Schleeter; and U.S. Pat. No. 4,933,016 by Carlson; and U.S. Pat. No. 4,889,147 by Chandler; and U.S. Pat. No. 5,638,843 by Strickland; and U.S. Pat. No. 5,800,087 by Tomasik.

### BACKGROUND OF INVENTION

The automobile washing industry has been dominated by stationary carwash stations that require a full building to house such stations. This stationary design greatly increases start up costs and virtually ties the carwash to its one original location only. Previous attempts at portable automobile washing apparatuses focused on providing U-shaped frame designs with nozzles or power washing units, but really not something that provided a full pre-rinse, brush-wash, rinse and air dry. What is needed is a mobile and portable automobile washing apparatus that can be quickly setup in virtually any location and can provide the normal range of carwash services expected.

### SUMMARY OF THE INVENTION

The instant invention, as illustrated herein, is clearly not anticipated, rendered obvious, or even present in any of the prior art mechanisms, either alone or in any combination thereof. A mobile and portable automobile washing apparatus designed to overcome the previously mentioned shortcomings would give commercial automobile washing facilities the ability to setup quickly in virtually any area, allowing them to move from place to place where it may be advantageous to do so while also reducing startup costs. Thus, the several embodiments of the instant invention are illustrated herein.

Therefore, it is an object of the present invention to overcome the previously mentioned shortcomings found in the prior art automobile washing apparatuses in a new improved mobile and portable automobile washing apparatus that is easy to manufacture, competitively priced and which may clean all surfaces of an automobile while providing the normal array of automobile washing services.

Another object of the present invention is to provide a mobile and portable automobile washing apparatus with a frame that is resistant to weathering.

Another object of the present invention is to provide a mobile and portable automobile washing apparatus with a frame that is coated with a water resistant material, such as acrylic, to protect against weathering.

Another object of the present invention is to provide a mobile and portable automobile washing apparatus with sides that may telescopically extend and contract.

Another object of the present invention is to provide a mobile and portable automobile washing apparatus with removably attached wheels, treads or other movement means including a braking means for said wheels, treads or other movement, means to prevent the apparatus from moving.

Another object of the present invention is to provide a mobile and portable automobile washing apparatus that may dispense any variety of fluids related to the practice of automobile washing via a fluid dispensing system.

Another object of the present invention is to provide a mobile and portable automobile washing apparatus that may dry automobiles that are washed by said apparatus.

Another object of the present invention is to provide a mobile and portable automobile washing apparatus that may accommodate automobiles of various sizes and dimensions by providing some simple to use, adjustable telescoping sides.

Another object of the present invention is to provide a mobile and portable automobile washing apparatus wherein the brushing members are turned by a motor coupled to a rotating belt system.

Another object of the present invention is to provide a mobile and portable automobile washing apparatus wherein the dimensions of the frame are easily adjustable by a series of powered cranks or hand cranks.

These together with other objects of the invention, along with various features of novelty which characterize the invention, are pointed out with particularity in the claims, Detailed Description of the Embodiments Sections and drawings of this application, with all said sections also adding to this disclosure.

### BRIEF DESCRIPTION OF THE DRAWINGS

FIG. 1 illustrates an isometric side view of the mobile and portable automobile washing apparatus. Visible are the frame and its component parts, two brush members hanging from said frame's top, a motor and rotating belt system mounted on said frame top, a fluid dispensing system, a plurality of cranks attached to said frame, three drying devices one on each side of the frame's rear, four wheel members where one is located at each frame corner, two handles where one handle is located the left frame side and one handle is located on the right frame side and one control unit.

### DETAILED DESCRIPTION OF THE DISCLOSED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as mobile automobile washing apparatuses with non-telescoping frame sides, and mobile automobile washing apparatuses of different shapes and dimensions.

Presently, mobile automobile washing apparatuses have failed to provide an efficient means of accommodating automobiles of a large range of sizes while providing uses the ability to offer the normal range of services expected by automobile washing apparatuses, as put forth by the present invention. Some previous apparatuses allow for the cleaning of the sides of a vehicle, but fail to provide a means effectively clean the top of a vehicle. Other systems provide the ability to clean the sides and tops of automobiles, but fail to clean the underside of vehicles and also fail to offer the typical array of automobile cleaning services expected to be offered by a modern automobile washing facility. Further, modern automobile washing facilities themselves are limited in that they are forced to remain in the location in which they were constructed.

The present invention solves all these prior shortcomings by introducing a mobile and portable automobile washing device that offers the services that are expected at a modern automobile washing facility. In addition, the use of a frame of telescoping sides allows for this mobile washing device to accommodate automobiles of various heights and lengths. Further, the use of telescoping frame sides makes it easier to store the automobile washing apparatus in smaller areas and makes it even easier to transport from location to location. Another useful feature of the present invention is the use of lockable wheels, treads or other surface movement means. This feature allows vehicles to pass through the apparatus frame or for the frame to be moved over and around the vehicle being washed.

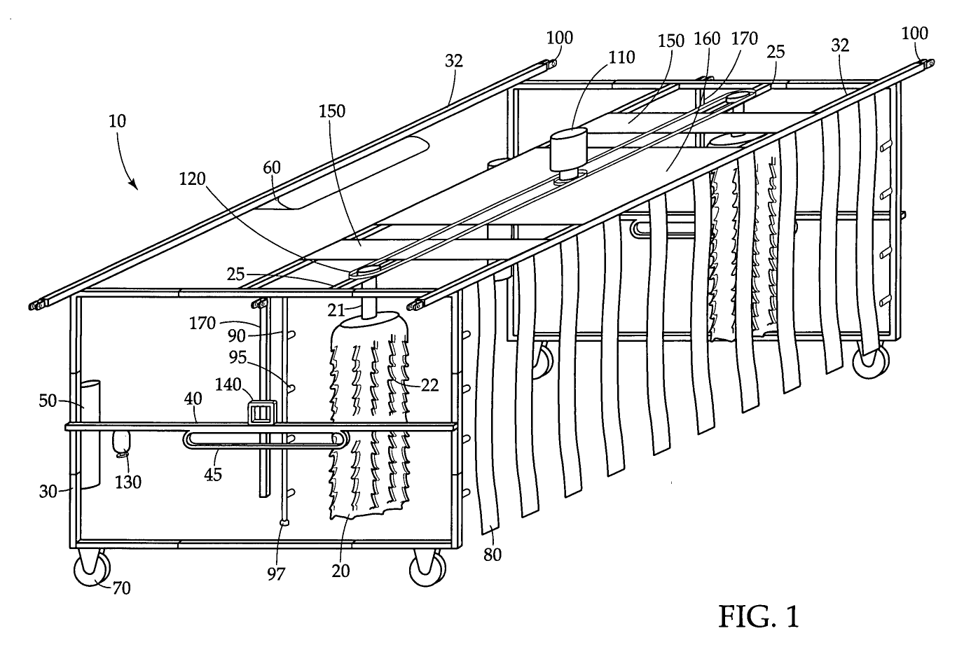

FIG. 1 shows an angled side view of the mobile automobile washing apparatus. Visible in FIG. 1 is the frame 10 comprises of four vertical support members 30, two top horizontal support members 32, four side horizontal support members 40, two side support members 45, one top central plate member 160, two top side plate members 150 and two brush member support bars 25, wherein all of said members being removably attached to each other at their respective attachment ends. Also, removably attached to the vertical and horizontal support members are one or more crank members 100 that are used to telescopically expand and contract the frame's 10 dimensions.

Also shown in FIG. 1 are two brush members 20 comprising a brush vertical member 21, and a plurality of brush textile strips 22, that may be comprised of any textile material know in the art including, but not limited to textile strips of feathery or downy textile materials, removably attached to said brush vertical member. One said brush member being located on the frame's 10 left side, and the other brush member being located on the frame's 10 right side. Each of said brush member hanging from its respective brush member support bar 25 which is removably attached to said brush vertical member 21.

FIG. 1 also displays the apparatus water dispersing system comprised of four sets of tubing 90 that hangs from the top horizontal support members 32 on the left and right sides of the apparatus itself, wherein one set of tubing hangs from center of the left side top horizontal support member 32 and one hangs from the front of the left side of top horizontal support member 32. The other two sets of tubing 90 hang from the right side top horizontal support member 32 in its respective center and front, in the same manner as the tubes 90 hang from the left side top horizontal support member 32 as mentioned above. Extending out of said four sets of tubing 90 are a plurality of nozzles 95 that disburse fluids as a spray. The fluid dispersing end of said nozzles 95 is always pointing toward the center of said apparatus. At the end of said sets of tubing 90 are located drainage valves 97 though which, when open, excess water may pass.

Further illustrated in FIG. 1 are the apparatus side drying units 50 and top drying unit 60. The two side drying units 50 are attached to the frame 10 on each one of the two rear vertical support members 30, while the top drying 60 unit is attached to the top rear of said frame 10.

Also illustrated by FIG. 1 is one embodiment of a means of brush rotation, being comprising a motor 110 mounted on said top central plate member 160 and further comprising two belt members 120. Said belt members 120 being mounted so that, the center belt ends are mounted about said motor 110 and so that, the non-center belt ends are mounted about said left and right brush vertical members 21.

Remaining features of the present invention illustrated in FIG. 1 include textile strips 80 hanging from the front top of said frame 10; wheel members 70 mounted to the bottom of said frame 10; a control unit 130 mounted to a side horizontal support member 40; and a fluid reservoir 130 mounted to a side horizontal support member 40.

What is claimed is:

1. A mobile vehicle-washing apparatus comprising:
a plurality of fluid dispensing apparatuses, wherein a variety of cleaning and rinsing fluids may be dispersed;
at least one mobility means wherein, said mobility means provides a means of locomotion for said apparatus along a surface;
at least two brushes, wherein at least one brush is located on said left frame side and at least one brush is located on said right frame side, said brushes further comprising:
at least one brush motion means;
at least one mobility means;
a brush location adjustment apparatus wherein, the left and right positions of said brushes may be changed;
a brush automation system wherein, said automation system provides the circular rotation motion means for said brushes;
a power supplying means wherein, the power for said fluid dispensing apparatuses, said brush automation system and other non-manual powered elements of said apparatus;
a frame comprising a left frame side and a right frame side; and,
at least two width beams comprising the width of said frame.

2. The mobile automobile-washing apparatus of claim 1, wherein said frame further comprises:
an inside;
a front side;
a back side;
at least four vertical support members wherein at least two of said support members are located on said left frame side and at least two of said support members are located on said right frame side;
at least two handle beam members that run along the length of said frame and attached to at least two of said vertical support members by an attachment means, wherein each of at least two said handle beam members further comprise at least one handle members protruding out of said handle beam members and are attached to said handle beam members by an attachment means;
at least two length beam members that form the length of the frame, said length beam members further comprising:
a first end;
a second end; and,
wherein two of said length beam members are outer edge length beam members and wherein said outer edge length beams are each attached to an individual of a set of at least two leg members on their respective left frame and right frame sides, wherein one of said set of at least two leg member is attached to said first end and said second end of each of said length beams.

3. The mobile automobile-washing apparatus of claim 2, wherein said brushes further comprise:
a centrally positioned vertical member wherein said vertical member is attached to and extends downwardly from one of said width beams; and
a plurality of textile material strips attached about said centrally positioned vertical member by a material-strip attachment means, wherein each of said material-strips further comprise an attachment end and a free end.

4. The mobile automobile-washing apparatus of claim 3, wherein said brush motion means further comprises:
a motor; and,
at least one belts contacting said motor wherein the motor may rotate the belts by a rotation means, thereby revolving said belts which in turn rotate said centrally positioned vertical member, wherein said plurality of textile material strips attached about said centrally positioned vertical member rotate with said centrally positioned vertical member.

5. The mobile automobile-washing apparatus of claim 4 further comprising at least two movable arm members wherein at least one arm member is attached to said right frame side and at least one arm member is attached to said left frame side by an attachment means, wherein said arm members further comprise:
a pivotally attached end;
a free end; and, a fluid dispensing apparatus.

6. The mobile automobile-washing apparatus of claim 5, wherein said brush location adjustment apparatus comprises a belt and pulley system.

7. The mobile automobile-washing apparatus of claim 6, wherein said mobility means is a means selected from a group consisting of wheels, treads, belts and rollers and further comprises a locking means to prevent said mobility means from moving.

8. The mobile automobile-washing apparatus of claim 7, wherein said leg members further comprise a vertical height adjustment means.

9. The mobile automobile-washing apparatus of claim 8, wherein said plurality of fluid dispensing apparatuses comprises:
a tubular member through which fluids may pass, wherein said tubular member is removably attached to said power supply means and is mounted about said frame; and,
a plurality of projecting nozzles comprising a fluid release end, wherein said nozzles extend out of said tubular member so as to allow said fluid release ends to face toward said inside of said frame, and wherein after said fluids pass through said nozzles, wherein said fluids are released as a spray.

10. The mobile automobile-washing apparatus of claim 9, wherein said automobile
washing apparatus further comprises:
a plurality of textile strips wherein said strips comprise an attached end, wherein said strips extend downwardly from said frame and are attached to said frame by said attachment end;
a plurality of air moving apparatuses; and,
a removably attached automobile drying system.

11. A mobile automobile-washing apparatus that comprises:
a plurality of water-soap dispensing apparatuses wherein, various fluids for cleaning and rinsing are disbursed;
at least one movement means wherein, said movement means provides a means of locomotion for said apparatus;
at least two brushes, wherein at least one brush is located on said left frame side and at least one brush is located on said right frame side, said brushes further comprising:
at least one brush motion means;
at least one mobility means;
an adjustable brush positioning system wherein, said positioning system allows for changing the left and right positioning of said brushes;
a powered water-distribution device wherein said powered water-distribution device provides a means of moving fluids through said water-soap dispensing apparatus;
a plurality of textile strips wherein said strips comprise an attached end, wherein said strips extend downwardly from said frame and are attached to said frame at said attachment end;
a plurality of air moving apparatuses wherein said air moving apparatuses provide a means of drying a vehicle;
an optional automobile drying system;
a frame comprising:
an inside;
a left side;
a right side;
a front;
a back;
at least two handle support beams, wherein at least one handle support beam runs along the length of said frame and is attached to at least two leg members by an attachment means, said handle support beams further comprising a gripping member protruding out of said handle beams;
at least four leg members wherein at least two leg members are located on said left side and at least two leg members are located on said right side;
a plurality of cranks, wherein one of said plurality of cranks is mounted on each of said leg members, and at least one crank is mounted on each of said width beams; wherein said cranks can be used to adjust said length and said width of said automobile washing apparatus;
at least two length beams that form the length of the frame, said length beams further comprising a first end and a second end;
at least two outer edge length beams, wherein said outer edge length beams are each attached to at least two leg members on their respective left and right frame sides and wherein exactly one leg member is attached to said first end and said second end of each of said length beams;
at least two width beam members, said width beam members further comprising a right end and a left end;
two outer edge width beams, wherein each said outer edge width beams are each attached to one leg member on its right end and attached to one leg member on its left end and is also attached to at least two length beams at the respective ends of said width beam and said length beam;
at least two brush members, wherein at least one brush member is located on said left frame side and at least one brush member is located on said right frame side, said brush members further comprising:
a centrally positioned vertical member wherein said vertical member is attached and extends downwardly from one of said width beams;
a plurality of textile material strips attached about said centrally positioned vertical member by a material-strip attachment means, wherein each of said material-strip further comprises an attachment end and a free end;
at least one brush rotation means comprising:
a motor;
at least one belts wherein said belts contact said motor and said centrally positioned vertical members, wherein said motor may rotate said belts and wherein said belts may then rotate said centrally positioned vertical member, wherein said plurality of textile material strips attached about said centrally positioned vertical member will rotate;
a plurality of automobile drying members attached to said frame by an attachment means.

12. The mobile automobile-washing apparatus of claim 11, wherein said frame further consists of at least two movable arm members wherein, at least one arm member is attached to said frame right side and at least one arm member is attached to said frame left side, wherein said arm members may swing underneath an automobile, and wherein said arm members are attached to said frame left side and said frame right side by a moveable-arm attachment means, said movable arm members further comprising:
an attached end;
a free end; and
a water-soap dispensing apparatus comprising a water-soap dispensing end, wherein said dispensing end is attached to said arm member free end by an attachment means.

13. The mobile automobile-washing apparatus of claim 12, wherein said mobility means is a means selected from a group consisting of wheels, treads and rollers and further comprises a locking means to prevent said mobility means from moving.

14. The mobile automobile-washing apparatus of claim 13, wherein said brush location adjustment means is a belt and pulley system.

15. The mobile automobile-washing apparatus of claim 14, wherein said centrally positioned vertical member is attached to a circular movement apparatus to allow said member to move in a circular motion.

16. The mobile automobile-washing apparatus of claim 15, wherein said powered water-distribution device is a powered water pump.

17. The mobile automobile-washing apparatus of claim 16, wherein said fluid dispensing apparatus further comprises:
a tubular member through which fluids may pass wherein said tubular member is removably attached to said power supply means and is mounted about said frame so as to be able to dispense fluids on the top side, left side and right side of any automobile passing through said frame; and
a plurality of projecting spouts comprising a fluid release end, wherein said nozzles extend out of said tubular member, wherein said fluid release ends always face toward said frame inside, and, wherein as said fluids pass through said nozzles said, fluids are released as a spray.

18. A method of using an all-dimension-adjustable mobile vehicle washing apparatus that comprises the steps of:
adjusting a length, width and height parameter of said vehicle washing apparatus to dimensions appropriate to those of a vehicle to be washed;
activating said vehicle-washing apparatus; and
allowing the vehicle to be washed by said vehicle-washing apparatus by a means selected from a group consisting of the following methods, allowing the vehicle to pass under and through a frame of said washing apparatus, and allowing the frame of said washing apparatus to move over and around said vehicle to be washed.

19. The method of using a length-width-height-adjustable mobile vehicle-washing apparatus of claim 18 wherein said apparatus comprises:
a plurality of fluid dispensing apparatuses comprising;
a tubular member through which fluids may pass wherein said tubular member is removably attached to said power supply means and is mounted about said frame so as to be able to dispense fluids on the top side, left side and right side of any automobile passing through said frame; and,
a plurality of projecting spouts comprising a fluid release end, wherein said nozzles extend out of said tubular member wherein said fluid release ends always face toward said frame inside, wherein as said fluids pass through said nozzles said fluids are released as a spray;
at least one movement means;
an adjustable brush positioning system comprising belts and pulleys;
a powered water pump;
a plurality of textile strips wherein said strips comprise an attached end, and wherein said strips extend downwardly from said frame and are attached to said from at said attachment end;
a plurality of air moving apparatuses;
an optional automobile drying system;
a frame comprising:
an inside;
a left side;
a right side;
a front side;
a back side;
at least four leg members wherein at least two leg members are located on said frame left side, at least two leg members are located on said frame right side, at least two leg members are located on said frame front side and at least two leg members are located on said frame back side;
at least two handle support members, wherein at least one handle support member runs along the length of said frame and is attached to at least two said leg members by an attachment means, said handle support beams further comprising a gripping member protruding out of said handle beams;
at least two length beam members wherein, said length beams further comprise, a first end and a second end, wherein two length beam members are outer edge length beam members, wherein said outer edge length beam members are each attached at least two leg members on their respective left and right frame sides by an attachment means and wherein exactly one leg member is attached to said first end and said second end of each of said length beam members,
at least two width beams forming the width of the frame, said width beams further comprising a right end and a left end;
two outer edge width beams comprising a right end and a left end, wherein said outer edge width beams are each attached to one of said leg members on its right end and attached to one leg member on its left end and is also attached to at least two length beams at the respective ends of said width beam and said length beam;
a plurality of cranks, wherein one crank is mounted on each of said leg members, and at least one crank is mounted on each of said width beams, wherein said cranks can be used to adjust said length and said width of said automobile washing apparatus;
at least two movable arm members wherein, at least one arm member is attached to said frame right side and at least one arm member is attached to said frame left side, wherein said arm members may swing underneath an automobile, and wherein said arm members are attached to said frame left side and said frame right side by a moveable-arm attachment means, said movable arm members further comprising:
an attached end;
a free end; and
a water-soap dispensing apparatus comprising a water-soap dispensing end, wherein said dispensing end is attached to said arm member free end by an attachment means;
at least two brushes, wherein at least one brush is located on said left frame side and at least one brush is located on said right frame side, said brushes further comprising:
a centrally positioned vertical member wherein said vertical member is attached and extends downwardly from one of said width beams;
a plurality of textile material strips attached about said centrally positioned vertical member by a material-strip attachment means, wherein each said material-strip further comprises an attachment end and a free end;
at least one brush rotation means comprising:
a motor;
at least two belts wherein said belts contact said motor and said centrally positioned vertical members, wherein said motor may rotate said at least two belts, and wherein said belts may then rotate said centrally positioned vertical member, wherein said plurality of textile material strips attached about said centrally positioned vertical member will rotate; and,
a plurality of automobile drying members attached to said frame by an attachment means.

20. The method of using a length-width-height-adjustable mobile vehicle-washing apparatus of claim 19 wherein the steps of using said apparatus further comprises the steps of:
dispensing a cleaning fluid over the vehicle being washed;
dispensing a rinsing fluid over the vehicle being washed; and
optionally drying the vehicle being washed by a drying means.
